(19) United States
(12) Patent Application Publication
(10) Pub. No.: US 2022/0345540 A1
(43) Pub. Date: Oct. 27, 2022

(54) ELECTRONIC APPARATUS EXECUTING SERVICE IN RESPONSE TO COMMAND FROM FRONT END APPARATUS AND FRONT END APPARATUS MANAGING ELECTRONIC APPARATUS

(71) Applicant: KYOCERA Document Solutions Inc., Osaka (JP)

(72) Inventor: Nobuhiro HARA, Osaka (JP)

(73) Assignee: KYOCERA Document Solutions Inc., Osaka (JP)

(21) Appl. No.: 17/719,076

(22) Filed: Apr. 12, 2022

(30) Foreign Application Priority Data
Apr. 26, 2021 (JP) 2021-074089
Apr. 26, 2021 (JP) 2021-074090

(51) Int. Cl. H04L 67/51; G06F 3/12; H04L 67/56

(52) U.S. Cl. CPC H04L 67/51; G06F 3/1291; G06F 3/1232; H04L 67/56; G06F 3/1203

(57) ABSTRACT

A management server includes: a service negotiator configured to identify a providable service which is able to be provided by each of a plurality of electronic apparatuses in correlation with the corresponding electronic apparatus; a service notifier configured to return a service discovery response including service identification information to a client terminal in response to reception of a service discovery request from the client terminal; and an electronic apparatus controller configured to stop return from the plurality of electronic apparatuses by transmitting a stop command for instructing to stop return of a response in response to the service discovery request from the client terminal to the plurality of electronic apparatuses and to transmit the service execution request to the corresponding electronic apparatus in response to reception of the service execution request for instructing to execute a service providable by one of the plurality of electronic apparatuses from the client terminal.

### INCORPORATION BY REFERENCE

This application claims priority to Japanese Patent Application No. 2021-074089 filed on Apr. 26, 2021, and Japanese Patent Application No. 2021-074090 filed on Apr. 26, 2021, the entire contents of which are incorporated by reference herein.

### BACKGROUND

The present disclosure relates to control of an electronic apparatus that is able to be connected to a network.

In so-called print centers and other companies that do print business, a plurality of image forming apparatuses employing various systems such as an ink-jet printing system, an offset printing system, and an electrophotographic system are connected to a network for use. In general, equipment capable of performing various post-processes such as a bookbinding process and a folding process is provided in image forming apparatuses. Management burdens in management of such a plurality of image forming apparatuses via a network exponentially increases as the number of systems in the image forming apparatuses increases, the number of types of the post-processes increases, and the number of apparatuses increases.

### SUMMARY

An aspect of the present disclosure provides an improvement of the aforementioned technique.

A front end apparatus according to an aspect of the present disclosure is a front end apparatus that is able to be connected to a plurality of electronic apparatuses capable of providing a service and a plurality of client terminals instructing to execute the service via a network. The front end apparatus includes a service negotiator, a service notifier, and an electronic apparatus controller. The service negotiator is configured to transmit a service discovery request to the plurality of electronic apparatuses by multicast in the network, to perform service negotiation with the plurality of electronic apparatuses in response to return of a service discovery response from the plurality of electronic apparatuses, and to identify a providable service which is able to be provided by each of the plurality of electronic apparatuses in correlation with the corresponding electronic apparatus. The service notifier is configured to return a service discovery response including service identification information indicating details of the providable service to the corresponding client terminal in response to reception of the service discovery request from the client terminal on the basis of the providable service identified through the service negotiation. The electronic apparatus controller is configured to transmit a stop command for stopping execution of the service in response to the service execution request, which is directly transmitted from the client terminal to the plurality of electronic apparatuses and which is used to instruct to execute a service which is able to be provided by one of the plurality of electronic apparatuses, to the plurality of electronic apparatuses and to transmit the service execution request to an electronic apparatus capable of executing the service out of the plurality of electronic apparatuses when the service execution request has been received from the client terminal.

An electronic apparatus according to another aspect of the present disclosure is an electronic apparatus that is able to be connected to a plurality of client terminals and a front end apparatus transmitting a service discovery response in response to a service discovery request from the plurality of client terminals by proxy via a network. The electronic apparatus includes a service executor and a control device. The service executor is configured to execute at least some services identified by service identification information indicating details of a service in response to reception of a service execution request for executing the at least some services. The control device includes a processor and serves as a service notifier and a controller by causing the processor to execute a front end apparatus control program. The service notifier is configured to return the service discovery response including the service identification information in response to reception of the service discovery request. The controller is configured to control the service executor. The controller is configured to stop reception of the service execution request from the plurality of client terminals when a command for instructing to stop reception of the service execution request for executing a service identified by the service identification information from the corresponding client terminal is received from the front end apparatus.

An electronic apparatus according to another aspect of the present disclosure is an electronic apparatus that is able to be connected to a plurality of client terminals and a front end apparatus transmitting a service discovery response in response to a service discovery request from the plurality of client terminals by proxy via a network. The electronic apparatus includes a service executor and a control device. The service executor is configured to execute at least some services identified by service identification information indicating details of a service in response to reception of a service execution request for executing the at least some services. The control device includes a processor and serves as a service notifier and a controller by causing the processor to execute a front end apparatus control program. The service notifier is configured to return the service discovery response including the service identification information in response to reception of the service discovery request. The controller is configured to control the service executor. The controller is configured to control the service notifier such that return of the service discovery response to the plurality of client terminals is stopped when a command for instructing to stop return of the service discovery response in response to the service discovery request from the plurality of client terminals is received from the front end apparatus.

### BRIEF DESCRIPTION OF THE DRAWINGS

FIG. 1 is a block diagram illustrating a functional configuration of an image forming system according to a first embodiment of the present disclosure.

FIG. 2 is a block diagram illustrating configurations of an image forming apparatus and a smartphone according to the first embodiment.

FIG. 3 is a flowchart illustrating details of a front end setting process according to the first embodiment.

FIG. 4 is a flowchart illustrating details of an IP address acquiring process according to the first embodiment.

FIG. 5 is a flowchart illustrating details of a service retrieving process according to a comparative example.

FIG. 6 is a diagram illustrating a routine of the service retrieving process according to the comparative example.

FIG. 7 is a flowchart illustrating details of a service retrieving process according to the first embodiment.

FIG. 8 is a diagram illustrating a routine of the service retrieving process according to the first embodiment.

FIG. 9 is a diagram illustrating a service notification status according to the first embodiment.

FIG. 10 is a flowchart illustrating details of a service retrieving process according to a second embodiment.

FIG. 11 is a diagram illustrating a routine of the service retrieving process according to the second embodiment.

FIG. 12 is a diagram illustrating a service notification status according to the second embodiment.

### DETAILED DESCRIPTION

Hereinafter, an electronic apparatus, a front end apparatus, a front end apparatus control method, an electronic apparatus control method, a non-transitory computer-readable recording medium storing a front end apparatus control program, and a non-transitory computer-readable recording medium storing an electronic apparatus control program according to an embodiment which is an aspect of the present disclosure will be described with reference to the accompanying drawings.

Modes for putting the present disclosure into practice (hereinafter referred to as “embodiments”) will be described with reference to the drawings in the following order:

A. First embodiment

B. Second embodiment; and

C. Modified example.

### A. First Embodiment

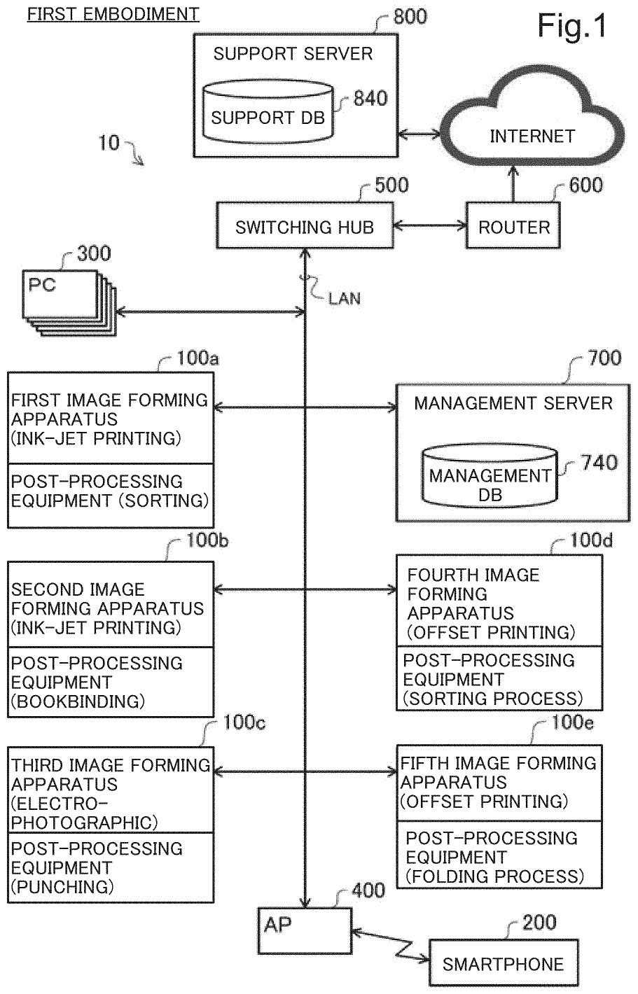

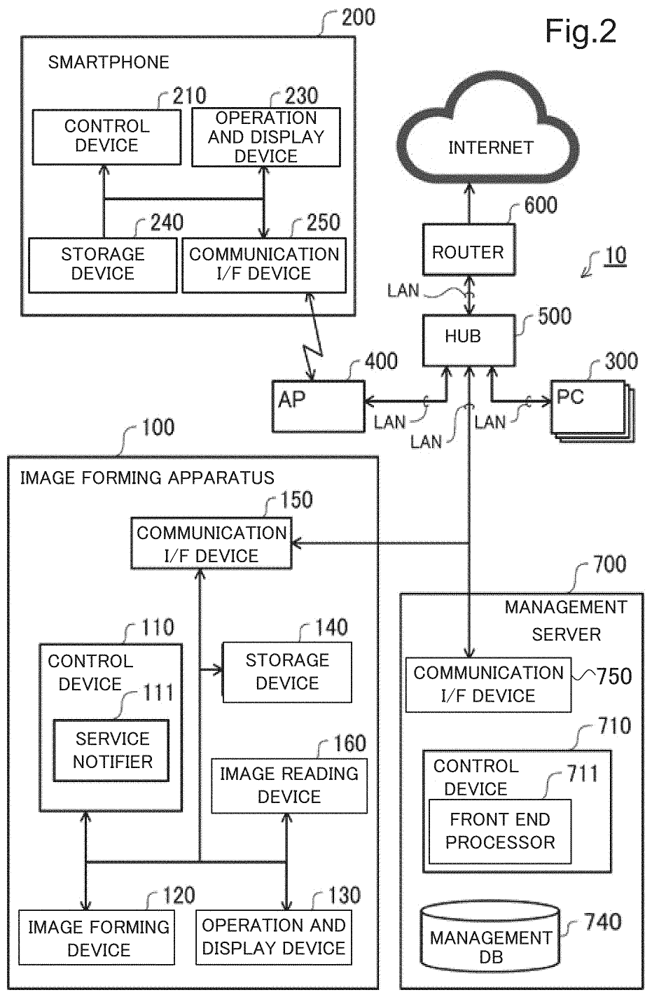

FIG. 1 is a block diagram illustrating a functional configuration of an image forming system 10 according to a first embodiment of the present disclosure. FIG. 2 is a block diagram illustrating configurations of an image forming apparatus 100 and a smartphone 200 according to the first embodiment. The image forming system 10 includes a plurality of image forming apparatuses 100, a smartphone 200, a plurality of personal computers (also simply referred to as PCs) 300, and a management server 700. The plurality of personal computers 300 serve as client terminals that instruct to execute services provided by the plurality of image forming apparatuses 100.

“Image forming apparatuses 100” is a collective term for a plurality of image forming apparatuses 100a to 100e that include a first image forming apparatus 100a, a second image forming apparatus 100b, a third image forming apparatus 100c, a fourth image forming apparatus 100d, and a fifth image forming apparatus 100e. The first image forming apparatus 100a is an ink-jet type image forming apparatus and is provided with post-processing equipment that can perform a sorting process. The second image forming apparatus 100b is an ink-jet type image forming apparatus and is provided with post-processing equipment that can perform a bookbinding process. The third image forming apparatus 100c is an electrophotographic type image forming apparatus and is provided with post-processing equipment that can perform a punching process. The fourth image forming apparatus 100d is an offset printing type image forming apparatus and is provided with post-processing equipment that can perform a sorting process. The fifth image forming apparatus 100e is an offset printing type image forming apparatus and is provided with post-processing equipment that can perform a folding process.

The image forming system 10 further includes a switching hub 500 and a router 600 constituting a local area network (also simply referred to as a network) LAN and a management server 700. The management server 700 includes a control device 710, a management database (also referred to as a management DB) 740, and a communication interface device (also referred to as a communication I/F device) 750. The control device 710 includes a front end processor 711. The function of the front end processor 711 will be described later. The management server 700 is also referred to as a front end apparatus.

The control device 710 is a unit including a main storage means such as a RAM or a ROM and a processor (a control means) such as a micro processing unit (MPU) or a central processing unit (CPU). The control device 710 has a controller function associated with an interface such as any of various I/Os, Universal Serial Bus (USB), a bus, or other hardware. The control device 710 takes charge of control of the whole operation of the management server 700. The control device 710 serves as the front end processor 711 by causing the processor to execute, for example, a front end apparatus control program stored in the ROM.

User information and resource information are stored in the management database 740. The user information includes details of a service to be used (for example, color ink-jet printing or offset printing), usage (for example, a printing size and the number of printed pages), and a delivery deadline which are required for a print job which each user takes charge of The user information is updated on the basis of printing order information from a business department. The resource information includes details of a providable service (for example, color ink-jet printing) which can be provided by the plurality of image forming apparatuses 100 and an hourly providable volume (for example, a printing size and the number of printed pages per hour). The resource information is updated on the basis of operation statuses of the plurality of image forming apparatuses 100 or resource statuses such as maintenance information, an available time period, and material inventory including materials and printing sheets.

The image forming system 10 is connected to a support server 800 via the Internet. The support server 800 stores a support database (also referred to as a support DB) 840 and manages a plurality of image forming apparatuses used by a plurality of users. The support database 840 stores the number of printed pages in each of the plurality of image forming apparatuses 100, charging information, supply management information of consumables, diagnosis data for providing a maintenance service such as failure diagnosis, and the like. The support database 840 stores software for realizing automatic update of software or an optional function in accordance with a request from a user.

The smartphone 200 includes a control device 210, an operation and display device 230, a storage device 240, and a communication interface device 250. The smartphone 200 can be connected to the image forming apparatuses 100 via an access point (also simply referred to as an AP) 400. Each image forming apparatus 100 includes a control device 110, an image forming device 120, an operation and display device 130, a storage device 140, a communication interface device (also referred to as a communication I/F device) 150, and an image acquiring device 160. The image forming device 120 executes an image forming service and is also referred to as a service execution device.

The image acquiring device 160 reads an image of an original document and generates image data. The image forming device 120 can form an image on an image forming medium in a plurality of operation modes including a copy mode and a network mode. The copy mode is an operation mode in which an image is formed on the basis of image data generated by the image acquiring device 160. The network mode is an operation mode in which an image is formed on the basis of a print job (also referred to as an image forming job) acquired via the network LAN.

The communication interface device 150 can perform communication over the Ethernet (registered trademark) via the wired network LAN. The access point 400, the plurality of personal computers 300, and the router 600 are connected to the communication interface device 150 via the switching hub 500. The communication interface device 150 can perform radio communication with the smartphone 200 via the access point 400.

The router 600 has a dynamic host configuration protocol (DHCP) server function and allocates IP addresses to the devices 100, 200, 300, and 700 serving as DHCP clients connected to the network LAN by dynamic allocation. In allocating an IP address, a term in which the IP address is valid (a lease term) is designated and the corresponding DHCP client updates the IP address before the lease term expires. The router 600 can re-allocate an IP address which has not been updated and of which the lease term has expired to another DHCP client.

The control devices 110 and 210 are units including a main storage means such as a RAM or a ROM and a processor (a control means) such as a micro processing unit (MPU) or a central processing unit (CPU). The control devices 110 and 210 have a controller function associated with interfaces such as various I/Os, a universal serial bus (USB), a bus, and other hardware. The control devices 110 and 210 control the image forming apparatus 100 and the smartphone 200 as a whole, respectively. The control device 110 serves as a service notifier 111 by causing the processor operate, for example, in accordance with an electronic apparatus control program stored in the storage device 140. That is, the control device 110 includes the service notifier 111. The function of the service notifier 111 will be described later.

The storage devices 140 and 240 store control programs (including an image forming program) or data of processes which are performed by the control devices 110 and 210 in a storage device including a hard disk drive or a flash memory which is a non-transitory recording medium. The operation and display devices 130 and 230 serve as touch panels to display various menus as an input screen and to receive a user's operation input.

A reliable apparatus list and a MAC address list which are identification information of the apparatuses are included in the storage device 140. Service set identifiers (SSID) of the apparatuses of which radio communication with the image forming apparatuses 100 is permitted are included in the reliable apparatus list. An SSID of a mobile terminal (for example, a specific smartphone 200) which can be used to access the management server 700 is registered in advance in the reliable apparatus list. Media access control addresses (MAC addresses) of the apparatuses of which radio communication with the image forming apparatuses 100 is permitted are included in the MAC address list. A MAC address of a mobile terminal (for example, a specific smartphone 200) which can be used to access the management server 700 is registered in advance in the MAC address list.

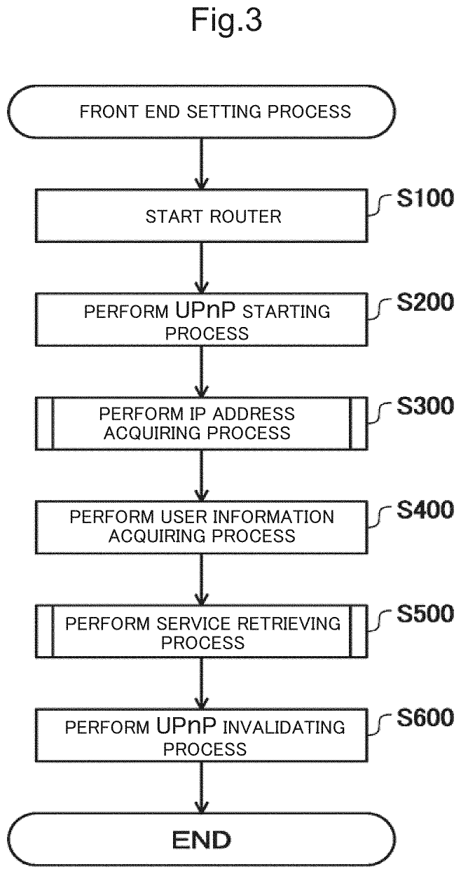

FIG. 3 is a flowchart illustrating details of a front end setting process according to the first embodiment. This wake-up process is typically performed in an image forming system 10 connected to a network LAN in which the switching hub 500 or the router 600 is powered off in the nighttime or the weekends in view of security or power save.

In Step S100, the router 600 is started with a timer or a system administrator's operation. In Step S200, the router 600 starts a universal plug and play (UPnP) function. Accordingly, the router 600 can smoothly perform addressing (allocating addresses) or discovery (detecting apparatuses) of the apparatuses over the network LAN. In Step S300, the router 600 performs an IP address acquiring process.

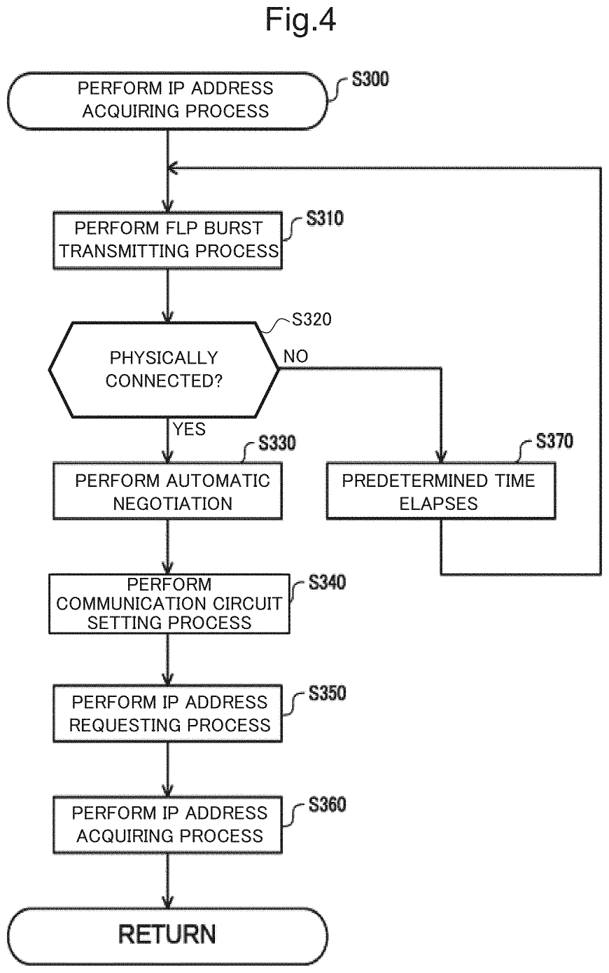

FIG. 4 is a flowchart illustrating details of the IP address acquiring process (Step S300) according to the first embodiment. In Step S310, the communication interface device 150 of an image forming apparatus 100 and the communication interface device 750 of the management server 700 transmit an FLP burst to the whole network LAN via the switching hub 500. The FLP burst is a signal which is transmitted in the standard of 10 Megabit Ethernet (registered trademark) (10Base-T).

The FLP burst includes 33 pulses. Odd-numbered pulses are clock pulses for taking a timing of the pulses. Even-numbered pulses are data pulses. The data pulse represents a transmission system which is supported by the corresponding apparatus. The transmission system is a combination of a transmission rate and a transmission mode (full duplex or half duplex). Full duplex is a communication mode in which two parties can simultaneously transmit and receive data to and from each other in bidirectional communication. Half duplex is a communication mode in which only one party can simultaneously transmit and receive data in bidirectional communication and transmission and reception of data in two directions are possible in a time division manner.

Specifically, for example, when the data pulses are supported by a combination of the standard of 10 Megabit Ethernet (registered trademark) and a transmission mode, a combination of the standard of 100 Megabit Ethernet (registered trademark) and a transmission mode, and a combination of the standard of 1000 Megabit Ethernet (registered trademark) and a transmission mode, the bit of the pulse at the corresponding position (even-numbered position) is 1 (there is a pulse). Accordingly, the FLP burst can notify an apparatus of a counter party of a transmission system which is supported by a transmission source thereof.

In Step S320, the routine progresses to Step S330 when it is determined that modular connectors (for example, RJ-45: not illustrated) of the communication interface devices 150 and 750 are physically connected to a network (the router 600 in this example), and the routine processes to Step S370 when it is determined that the modular connectors are not physically connected to the network.

The communication interface devices 150 and 750 determines that the image forming apparatus 100 and the management server 700 are physically connected to the network when the FLP burst is returned while both the switching hub 500 and the router 600 are operating. On the other hand, the communication interface devices 150 and 750 determine that the image forming apparatus 100 and the management server 700 are not physically connected to the network when the FLP burst is not returned within a predetermined time while at least one of the switching hub 500 and the router 600 is not operating (for example, powered off).

In Step S330, the communication interface devices 150 and 750 start an automatic negotiation process. In the automatic negotiation process, the communication interface devices 150 and 750 automatically select a system with the highest priority out of the transmission systems which are supported by both the transmission source of the FLP burst (the router 600 in this example) and the communication interface devices 150 and 750. In this example, it is assumed that 100BASE-T (full duplex) is selected as the transmission system by both as the result of the automatic negotiation process.

In Step S340, the communication interface devices 150 and 750 perform a communication circuit setting process. In the communication circuit setting process, the communication interface devices 150 and 750 set a communication circuit to 100BASE-T (full duplex) selected through the automatic negotiation process for communication with the router 600.

In Step S350, the communication interface devices 150 and 750 perform an IP address requesting process. In the IP address requesting process, the communication interface devices 150 and 750 broadcast a DHCPDISCOVER message in the network

LAN. The DHCPDISCOVER message is a message for discovering a DHCP server.

The router 600 having a DHCP server function serves as a DHCP server and broadcasts a DHCPOFFER message in the network LAN as a response to the DHCPDISCOVER message. The DHCPOFFER message includes an IP address and other information (setting parameters such as a subnet mask or DNS). In this example, it is assumed that the router 600 sets a lease term of an IP address to be less than 24 hours, for example, to 20 hours. Accordingly, the communication interface devices 150 and 750 need to update the IP addresses everyday.

In Step S360, the communication interface devices 150 and 750 perform an IP address acquiring process. In the IP address acquiring process, the communication interface devices 150 and 750 receive and analyze the DHCPOFFER message, set the IP addresses leased in the DHCPOFFER message as the IP addresses of the communication interface devices 150 of the image forming apparatuses 100 and the communication interface device 750 of the management server 700, and perform communication setting using other information acquired from the DHCPOFFER message. Accordingly, the plurality of image forming apparatuses 100 and the management server 700 can access the router 600 on the basis of the Ethernet and the TCP/IP protocol and perform Internet communication via the router 600.

In Step S400 (see FIG. 3), the management server 700 performs a user information acquiring process. In the user information acquiring process, the management server 700 acquires user information, that is, details of a service to be used (for example, color ink-jet printing), usage (a printing size and the number of printed pages), and a delivery deadline which are required for a print job which each user takes charge of, from the management database 740.

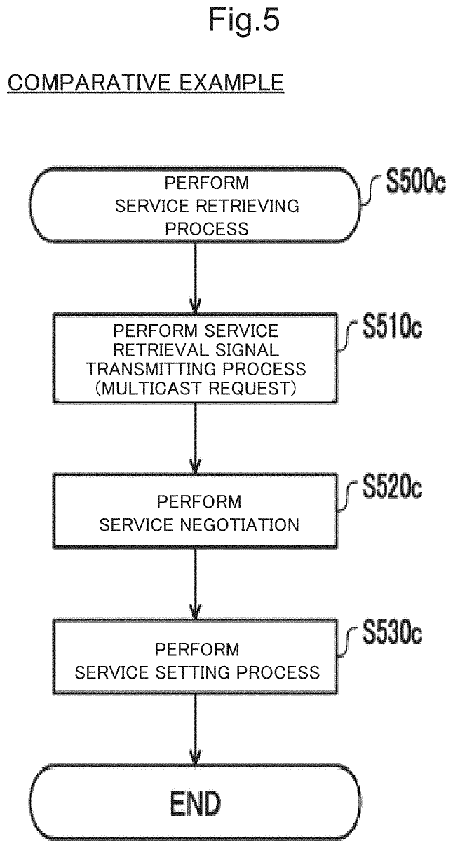

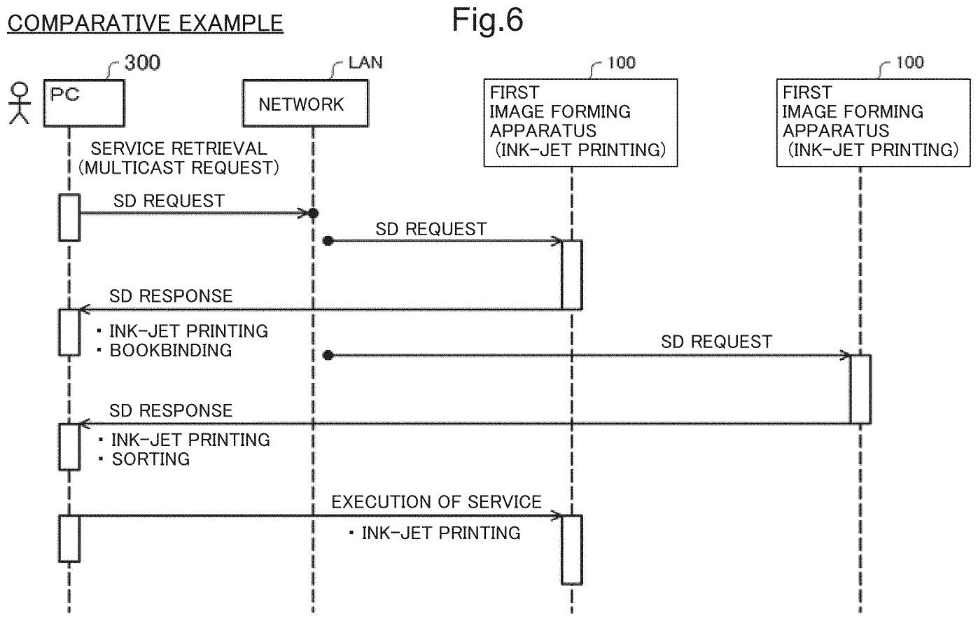

FIG. 5 is a flowchart illustrating details of a service retrieving process (Step S500c) according to a comparative example. FIG. 6 is a diagram illustrating a routine of the service retrieving process according to the comparative example. In FIG. 6, only the first image forming apparatus 100a and the second image forming apparatus 100b are illustrated for the purpose of easy understanding.

The service retrieving process is also referred to as service discovery and is a process of identifying positions of apparatuses (for example, the image forming apparatuses 100) that can provide various services. The service retrieving process according to the comparative example is a process in which the management server 700 serving as a front end is not employed. The function of the front end will be described later.

In Step S510c, each of a plurality of personal computers 300 performs a service retrieval signal transmitting process. In the service retrieval signal transmitting process, each personal computer 300 transmits a service discovery request (also referred to as an SD request (see FIG. 6)) including its own IP address by multicast or broadcast.

In Step S520c, the service notifier 111 of the control device 110 of each of the plurality of image forming apparatuses 100 returns a service discovery response (also referred to as an SD response (see FIG. 6)) including an IP address to the personal computers 300 via the communication interface device 150 by unicast. The SD response includes service identification information which is information for identifying details of a service. Specifically, for example, when the first image forming apparatus 100a transmits the SD response, details of a service include “ink-jet printing” and “sorting process (post-processing).”

In Step S530c, each personal computer 300 performs a service setting process. In the service setting process, each personal computer 300 receives an SD response, analyzes the received SD response, and extracts service identification information and an IP address therefrom.

Accordingly, each personal computer 300 can acquire IP addresses for using the services of the plurality of image forming apparatuses 100. The plurality of image forming apparatuses 100 can selectively use the services using their own drivers (also referred to as control programs). Specifically, for example, each personal computer 300 can transmit a print job to the first image forming apparatus 100a to perform ink-jet printing (see FIG. 6).

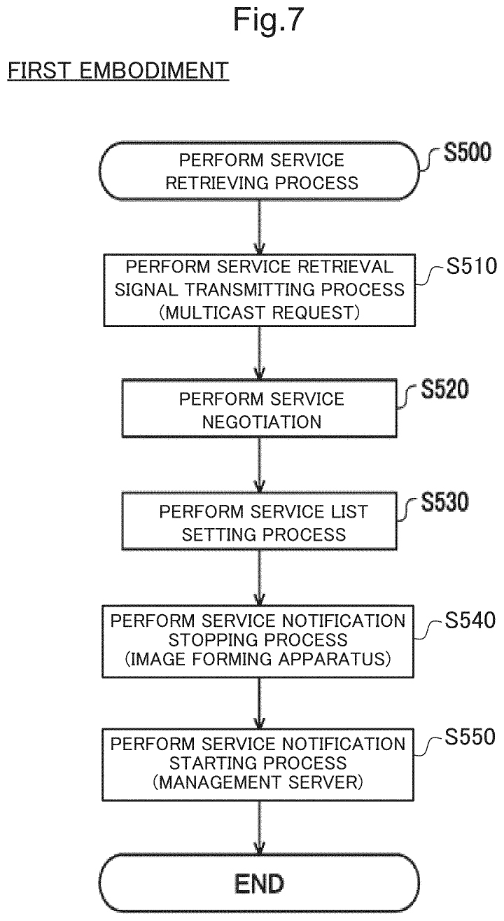

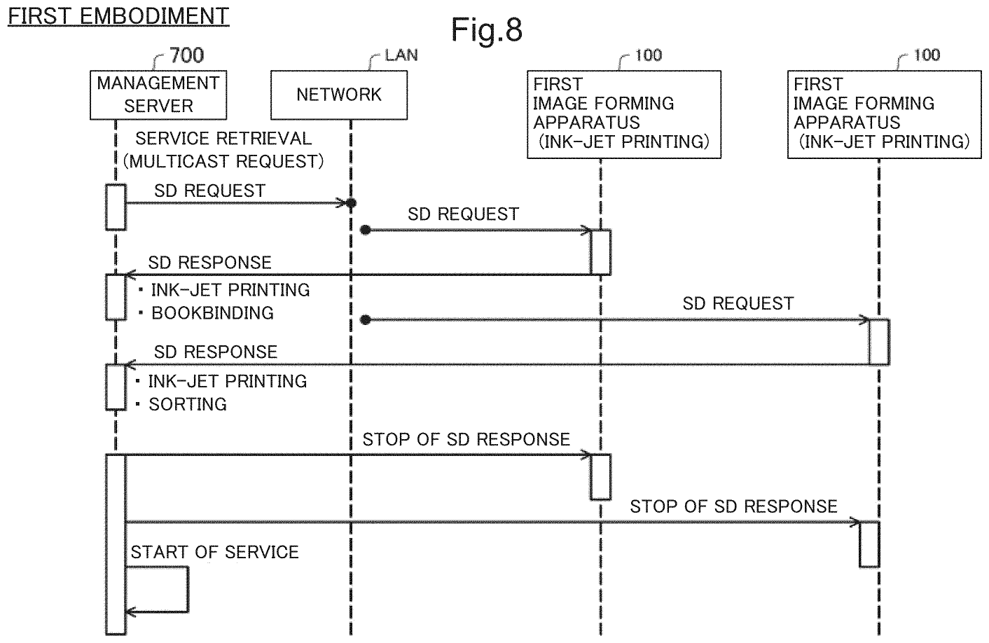

FIG. 7 is a flowchart illustrating details of a service retrieving process according to the first embodiment. FIG. 8 is a diagram illustrating a routine of the service retrieving process (Step S500) according to the first embodiment. The service retrieving process according to the first embodiment is a process in which the management server 700 serving as a front end is employed. The front end is an apparatus that comprehensively controls services performed by a plurality of terminals (the plurality of image forming apparatuses 100 in this example) and intensively manages operation statuses of the terminals or execution statuses and execution volumes of the services.

In Step S510, a front end processor 711 of the control device 710 of the management server 700 performs a service retrieval signal transmitting process. In the service retrieval signal transmitting process, the management server 700 transmits an SD request (see FIG. 8) including its own IP address to the plurality of image forming apparatuses 100 by multicast. The SD request includes details of a service to be used and usage which are set on the basis of user information of a plurality of users read from the management database 740. Accordingly, the front end processor 711 starts service negotiation.

In Step S520, the front end processor 711 serves as a service negotiator and performs service negotiation with the plurality of image forming apparatuses 100. In the service negotiation, the plurality of image forming apparatuses 100 return an SD response (see FIG. 8) including their own IP addresses to the management server 700 by unicast. The SD response includes service identification information which is information for identifying details of providable services which are services providable by the plurality of image forming apparatuses 100 in correlation with the plurality of image forming apparatuses 100. Specifically, for example, when the first image forming apparatus 100a transmits the SD response over the network, details of the service include “ink-jet printing” and “sorting (post-processing).”

In this way, in the service negotiation, the front end processor 711 requests the plurality of image forming apparatuses 100 to provide a service on the basis of the user information of the plurality of users in place of the plurality of users. The front end processor 711 additionally sets priority of a print job which each user takes charge of on the basis of the delivery deadline according to necessity. The print job is also referred to as a service execution request and has a broad concept including a job other than printing such as monitoring an operation status.

In Step S530, the management server 700 performs a service list setting process. In the service list setting process, the front end processor 711 analyzes the received SD response and extracts the service identification information and the IP addresses. The front end processor 711 stores the service identification information and the IP addresses of the plurality of image forming apparatuses 100 as a database and registers the database as available service data in the management database 740. In this example, the IP addresses are set as master keys.

The management server 700 allocates providable services to the users on the basis of the user information and the available service data. The management server 700 gives a right for use of a service allocated to each user via the personal computers 300 in response to log-in on the plurality of personal computers 300.

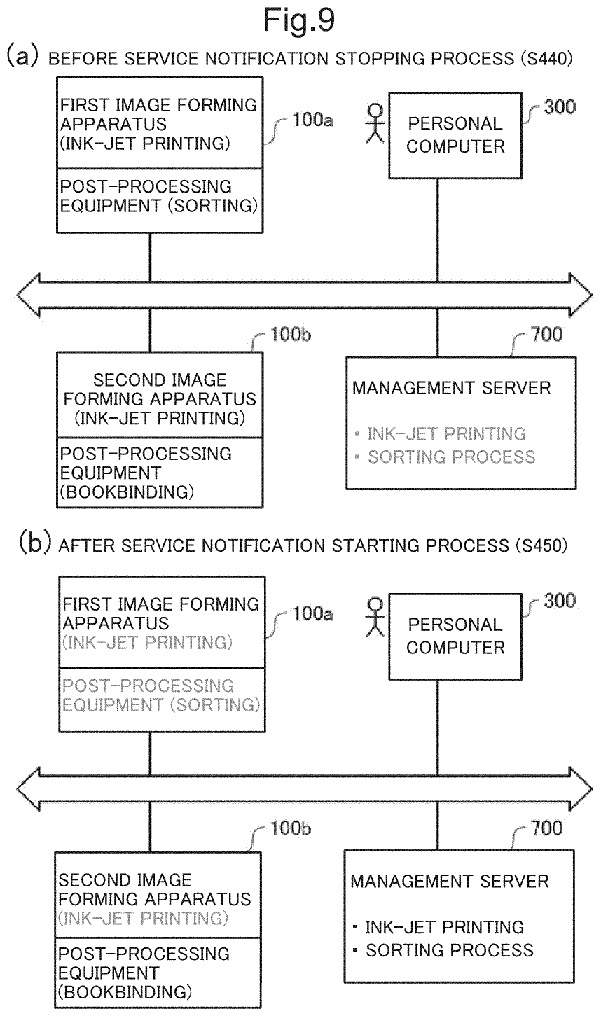

FIG. 9 is a diagram illustrating a service notification state according to the first embodiment. FIG. 9(a) illustrates a service notification state in Steps S510 to S530. In this state, the management server 700 does not serve as a front end, services of “ink-jet printing” and “sorting process” are provided from the first image forming apparatus 100a, and services of “ink-jet printing” and “bookbinding process” are provided from the second image forming apparatus 100b.

In Step S540, the management server 700 serves as an electronic apparatus controller of the front end and performs a service notification stopping process on the basis of the database. In the service notification stopping process, the management server 700 transmits an IP packet including a command for instructing to stop return of an SD response in response to the SD request from each personal computer 300 or the like (see Step S510c) to the plurality of image forming apparatuses 100 (see FIG. 8). The plurality of image forming apparatuses 100 are set not to return the SD response in response to the SD request from an apparatus other than the management server 700 by receiving this command.

FIG. 9(b) illustrates a service notification state after the process of Step S550 has been performed. In Step S550, the management server 700 serves as a service notifier of the front end and performs a service notification starting process on the basis of the database. In the service notification starting process, the management server 700 returns an SD response to the personal computers 300 by unicast (see Step S520c) in response to the SD requests from the personal computers 300 (see Step S510c).

In the example illustrated in FIG. 9(b), one personal computer 300 is permitted in “ink-jet printing” and “sorting” but is not permitted in “bookbinding.” In this example, this is because a user of the personal computer 300 does not need “bookbinding” for the print job in charge and a right for “bookbinding” is not given thereto. In this example, the second image forming apparatus 100b can perform bookbinding of prints on which images are formed by another image forming apparatus 100 without being controlled by the management server 700.

For example, since an image to be printed cannot be satisfactorily ascertained by the smartphone 200, a right for only services which are management such as monitoring operation statuses of a plurality of image forming apparatuses 100 or the order of processes may be given. This management of a right can be intensively simply set by a system administrator who manages the management server 700.

In this way, each personal computer 300 seems to have a feeling as if the services of the plurality of image forming apparatuses 100 are provided at only the position (IP address) of the management server 700. Accordingly, a print job is transmitted necessarily via the management server 700, the likelihood that a service not using the management server 700 will be able to be individually performed by each terminal (the plurality of image forming apparatuses 100 in this example) can be excluded, and operation statuses or resource statuses of services can be reliably managed by the management server 700 serving as a front end.

The service notification stopping process can be manually performed for each terminal, but an excessive burden due to an increase in the number of terminals or a dynamic change in configuration may be caused. This burden is resolved by the management server 700.

In Step S600, since the image forming system 10 is in an operable state, the management server 700 requests the router 600 to invalidate a universal plug and play (UPnP) function. The router 600 can invalidate the UPnP to increase a security level of the image forming system 10.

In this way, with the image forming system 10 according to the first embodiment, the management server 700 can automatically stop transmission of an SD response from each terminal and transmit an SD response in place of the terminals. Accordingly, the image forming system 10 can enable simple introduction of the management server 700 serving as a front end into the network and realize reliable management of operation statuses or execution results of services in the management server 700.

### B. Second Embodiment

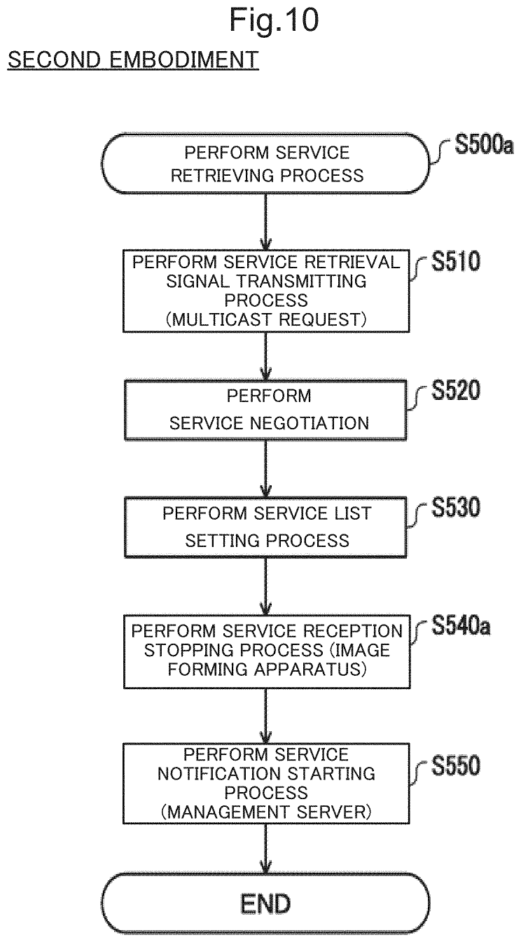

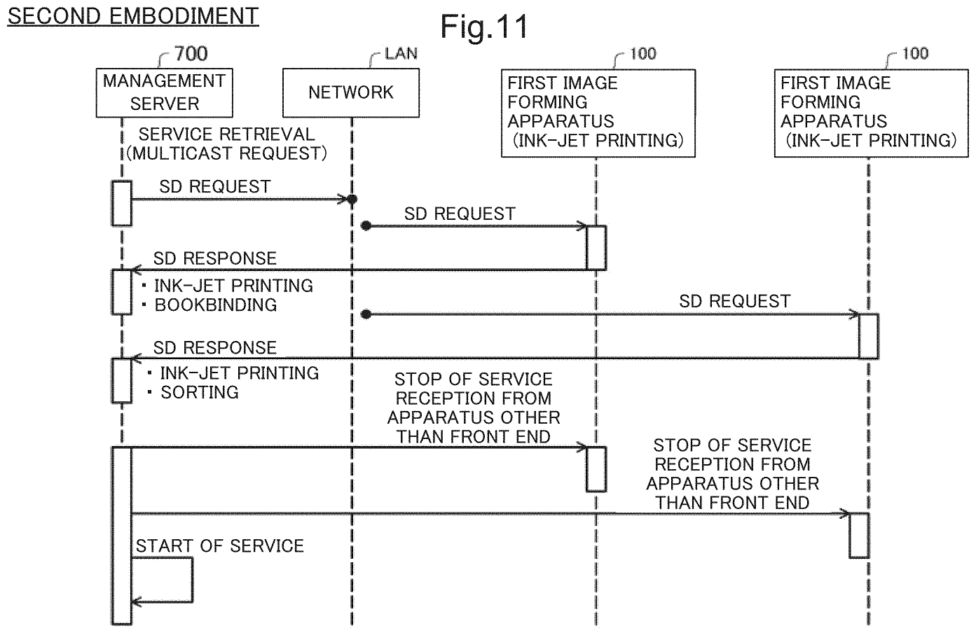

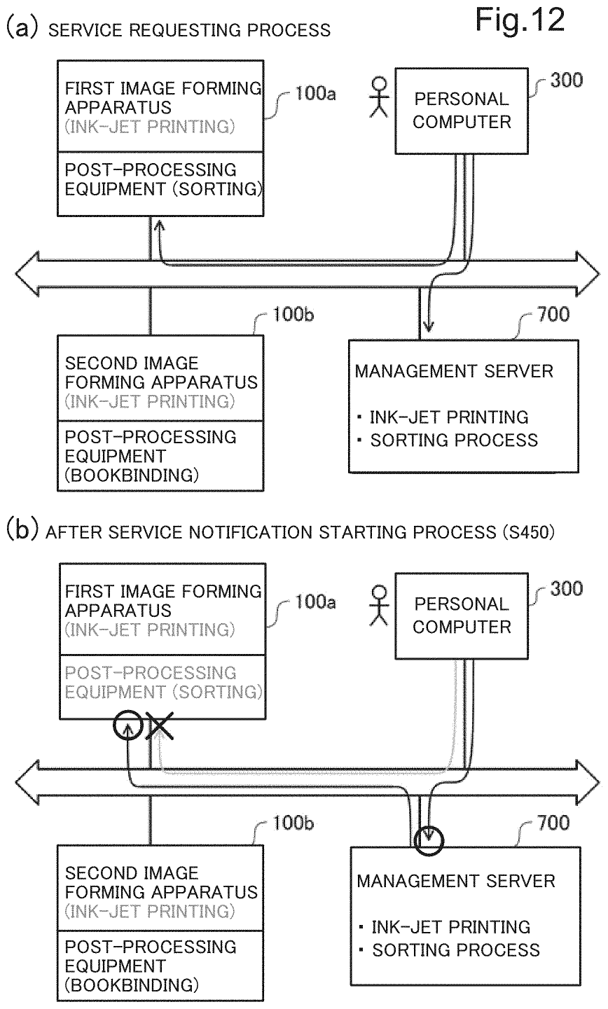

FIG. 10 is a flowchart illustrating a service retrieving process according to a second embodiment. FIG. 11 is a diagram illustrating a routine of the service retrieving process according to the second embodiment. FIG. 12 is a diagram illustrating a service notification state according to the second embodiment. The service retrieving process (Step S500a) according to the second embodiment is different from the service retrieving process (Step S500a) according to the first embodiment in that the service notification stopping process (Step S540) is replaced with a service reception stopping process (Step S540a).

In Step S540a, the management server 700 serves as an electronic apparatus controller and transmits an IP packet including a command for instructing to stop reception of a service execution command from an apparatus other than the management server 700 to a plurality of image forming apparatuses 100. The plurality of image forming apparatuses 100 are set to reject a service execution command from an apparatus other than the management server 700 by receiving this command.

FIG. 12 is a diagram illustrating a service notification state according to the second embodiment. With the service retrieving process according to the second embodiment, even when each personal computer 300 requests at least some of the plurality of image forming apparatuses 100 to execute a service, the service execution command not using the management server 700 is rejected. As a result, the likelihood that a service not using the management server 700 will be able to be individually performed by each terminal can be excluded, and operation statuses of services or execution results can be reliably managed by the management server 700 serving as a front end.

The service retrieving process according to the second embodiment can also be performed in combination with the service retrieving process according to the first embodiment. That is, the management server 700 may perform both the service notification stopping process and the service reception stopping process in addition to only the service reception stopping process. With this configuration, it is possible to reduce useless communication in the network.

In general, there is a trade-off problem in that convenience for a user is improved but a burden on a manager is increased when a front end is introduced into the network. On the other hand, with the aforementioned embodiments, it is possible to enhance convenience for a user by introducing a front end while curbing an increase in burden for network management.

### C. Modified Examples

The present disclosure can also be realized as following modified examples in addition to the aforementioned embodiments.

Modified Example 1: In the aforementioned embodiments, the front end function is performed by the management server 700, but an apparatus serving as the management server does not have to be employed. Specifically, one of a plurality of image forming apparatuses 100 or one of a plurality of personal computers 300 may have the front end function.

Modified Example 2: In the aforementioned modified example, the front end function is provided in one of the plurality of image forming apparatuses 100 or one of the plurality of personal computers 300, but the front end function may be provided in a plurality of terminals. When the front end function is provided in a plurality of terminals, for example, priorities can be set, a terminal with the highest priority can operate, and the other terminals can mirror the management database 740. With this configuration, one of a plurality of terminals in which the front end function is provided can normally provide the front end function and thus it is possible to realize a system with high robustness. In this example, an image forming apparatus 100 or a personal computer 300 is also referred to as a front end apparatus.

Modified Example 3: In the aforementioned embodiments, an image forming apparatus stops return of a service discovery response or reception of a service execution request in accordance with a command from the front end apparatus, but may be set to a state in which return of a service discovery response or reception of a service execution request, for example, from an apparatus other than a preset front end apparatus in an initial state at the time of start (including the time of start from a sleep state) is stopped.

In this set state, when he control device 110 of an image forming apparatus may return a service discovery response in response to a service discovery request from the front end apparatus, request the front end apparatus to transmit a service discovery request when a service discovery request from an apparatus other than the front end apparatus is received before the service discovery request from the front end apparatus is received, and return a service discovery response to the apparatus other than the front end apparatus when a service discovery request from the front end apparatus is not received within a preset time.

With this configuration, it is possible to prevent a situation in which the control device of the image forming apparatus can receive a service discovery request from a client terminal earlier than the front end apparatus and return a service discovery response before a command for stopping return of a service discovery response is received by the front end apparatus. The image forming system can smoothly automatically transition to an operation mode in which the front end apparatus is not employed even if all the front end apparatuses fall into failure.

At this time, when a service discovery response has been returned to an apparatus other than the front end apparatus, the control device of the image forming apparatus may automatically notify a preset contact address (for example, a system administrator) of an abnormality of the front end apparatus.

Modified Example 4: In the aforementioned embodiments, the router 600 has the DHCP server function, but a configuration in which a server having the DHCP server function is provided in the network may be employed. The network having the DHCP server function can be a network including a node having the DHCP server function.

Modified Example 5: In the aforementioned embodiments, a plurality of image forming apparatuses 100 are employed as terminals, but the present disclosure is not limited to image forming apparatuses performing an image forming operation and can also be applied to other electronic apparatuses that can provide various servers (that is, execute various types of j obs).

While the present disclosure has been described in detail with reference to the embodiments thereof, it would be apparent to those skilled in the art the various changes and modifications may be made therein within the scope defined by the appended claims.

What is claimed is:

1. A front end apparatus that is able to be connected to a plurality of electronic apparatuses capable of providing a service and a plurality of client terminals instructing to execute the service via a network, the front end apparatus comprising a control device, the control device including a processor and serving as, by causing the processor to execute a front end apparatus control program:
a service negotiator configured to transmit a service discovery request to the plurality of electronic apparatuses by multicast in the network, to perform service negotiation with the plurality of electronic apparatuses in response to return of a service discovery response from the plurality of electronic apparatuses, and to identify a providable service which is able to be provided by each of the plurality of electronic apparatuses in correlation with the corresponding electronic apparatus;
a service notifier configured to return a service discovery response including service identification information indicating details of the providable service to the corresponding client terminal in response to reception of the service discovery request from the client terminal on the basis of the providable service identified through the service negotiation; and
an electronic apparatus controller configured to transmit a stop command for stopping execution of the service in response to the service execution request, which is directly transmitted from the client terminal to the plurality of electronic apparatuses and which is used to instruct to execute a service which is able to be provided by one of the plurality of electronic apparatuses, to the plurality of electronic apparatuses and to transmit the service execution request to an electronic apparatus capable of executing the service out of the plurality of electronic apparatuses when the service execution request has been received from the client terminal.

2. The front end apparatus according to claim 1, wherein the electronic apparatus controller is configured to cause the plurality of electronic apparatuses to stop execution of the service in response to the service execution request directly transmitted from the client terminal by transmitting a command for instructing to stop reception of the service execution request for executing the providable service from the client terminal as the stop command to the plurality of electronic apparatuses to stop return of the service discovery response from the plurality of electronic apparatuses.

3. The front end apparatus according to claim 2, wherein the electronic apparatus controller is configured to cause the plurality of electronic apparatuses to stop reception of the service execution request from the client terminal by transmitting a command for instructing to stop return of the service discovery response from the plurality of electronic apparatuses to the plurality of electronic apparatuses in response to the service discovery request from the client terminal.

4. An electronic apparatus that is able to be connected to a plurality of client terminals and a front end apparatus transmitting a service discovery response in response to a service discovery request from the plurality of client terminals by proxy via a network, the electronic apparatus comprising:
a service executor configured to execute at least some services identified by service identification information indicating details of a service in response to reception of a service execution request for executing the at least some services; and
a control device, the control device including a processor and serving as, by causing the processor to execute a front end apparatus control program:
a service notifier configured to return the service discovery response including the service identification information in response to reception of the service discovery request; and
a controller configured to control the service executor,
wherein the controller is configured to stop reception of the service execution request from the plurality of client terminals when a command for instructing to stop reception of the service execution request for executing a service identified by the service identification information from the corresponding client terminal is received from the front end apparatus.

5. The electronic apparatus according to claim 4, wherein the controller includes a set state for using the front end apparatus, and
wherein, in the set state, the controller is configured to return the service discovery response in response to the service discovery request from the front end apparatus, to request the front end apparatus to transmit the service discovery request when the service discovery request is received from an apparatus other than the front end apparatus before the service discovery request from the front end apparatus has been received, and to return the service discovery response to the apparatus other than the front end apparatus when the service discovery request has not been received from the front end apparatus within a preset time.

6. The electronic apparatus according to claim 5, wherein the controller is configured to automatically notify an abnormality of the front end apparatus to a preset contact address when the service discovery response has been returned to the apparatus other than the front end apparatus.

7. The front end apparatus according to claim 1, wherein the electronic apparatus controller is configured to cause the plurality of electronic apparatuses to stop execution of the service in response to the service execution request directly transmitted from the client terminal by transmitting a command for instructing to stop return of the service discovery response from the plurality of electronic apparatuses in response to the service discovery request from the client terminal as the stop command to the plurality of electronic apparatuses to stop return of the service discovery response from the plurality of electronic apparatuses.

8. The front end apparatus according to claim 7, wherein the electronic apparatus controller is configured to cause the plurality of electronic apparatuses to stop reception of the service execution request from the client terminal by transmitting a command for instructing to stop reception of the service execution request for executing the providable service from the client terminal to the plurality of electronic apparatuses.

9. An electronic apparatus that is able to be connected to a plurality of client terminals and a front end apparatus transmitting a service discovery response in response to a service discovery request from the plurality of client terminals by proxy via a network, the electronic apparatus comprising:
a service executor configured to execute at least some services identified by service identification information indicating details of a service in response to reception of a service execution request for executing the at least some services; and
a control device, the control device including a processor and serving as, by causing the processor to execute a front end apparatus control program:
a service notifier configured to return the service discovery response including the service identification information in response to reception of the service discovery request; and
a controller configured to control the service executor,
wherein the controller is configured to control the service notifier such that return of the service discovery response to the plurality of client terminals is stopped when a command for instructing to stop return of the service discovery response in response to the service discovery request from the plurality of client terminals is received from the front end apparatus.

10. The electronic apparatus according to claim 9, wherein the controller includes a set state for using the front end apparatus, and
wherein, in the set state, the controller is configured to return the service discovery response in response to the service discovery request from the front end apparatus, to request the front end apparatus to transmit the service discovery request when the service discovery request is received from an apparatus other than the front end apparatus before the service discovery request from the front end apparatus has been received, and to return the service discovery response to the apparatus other than the front end apparatus when the service discovery request has not been received from the front end apparatus within a preset time.

11. The electronic apparatus according to claim 10, wherein the controller is configured to automatically notify an abnormality of the front end apparatus to a preset contact address when the service discovery response has been returned to the apparatus other than the front end apparatus.
